(19) United States
(12) Patent Application Publication
(10) Pub. No.: US 2007/0085326 A1
(43) Pub. Date: Apr. 19, 2007

(54) Folder binding device

(76) Inventor: Chun Fu Fu, Fongyuan City (TW)

Correspondence Address: PRO-TECHTOR INTERNATIONAL SERVICES, 20775 NORADA CT., SARATOGA, CA, 95070, US

(21) Appl. No.: 11/251,178

(22) Filed: Oct. 13, 2005

(51) Int. Cl. B42D 1/00

(52) U.S. Cl. 281/21.1

(57) ABSTRACT

Provided is a folder binding device comprising a binding assembly including a table inclined toward rear, two uprights at both rear corners of the table, a platen moveably provided across the uprights, a central rod extended upward from the platen, and two parallel guide posts extended upward from positions proximate both ends of the platen; and a detachable heater including a front heating member. Placing one or more folders on the table with a joint of each folder facing the platen wherein each folder has orderly sheets put together by adhesive, lowering the platen by pushing down the rod to press the joint of each folder and cause each joint to be in contact with the heating member, and activating the heating member will melt the adhesive in each folder to bind the sheets thereof after cooling.

### BACKGROUND OF THE INVENTION

1. Field of Invention

The present invention relates to binding devices and more particularly to a device for binding one or more folders in one heating operation.

2. Related Art

A conventional folder 10 is shown in FIGS. 1 to 4. The folder 10 is rectangular and comprises a lengthwise central spine 11 and an adhesive 12 formed on an inner surface of the spine. 11. A plurality of sheets of file(s) are orderly placed on one half of the folder 10. Next, fold the other half of the folder 10 toward one half thereof about the adhesive 12. Next, place the folder 10 in a substantially U-shaped groove 21 of a binder 20 to rest the spine 11 upon a heating pad 22 on the bottom of the groove 21. Next, activate the heating pad 22 to heat the folder 10. The adhesive 12 is thus melted to completely bind the sheets of file(s). As a result, the purpose of binding file(s) is achieved after cooling.

However, the prior art suffered from a couple of disadvantages. For example, width of the groove 21 is limited. Hence, only a limited number of sheets are adapted to bind one time. Further, a person has to use one or two hands to hold the folder 10 upright in the heating process if the folder 10 has only a few sheets (i.e., the space of the groove 21 is not sufficiently utilized) as shown in FIG. 4. Thus, the need for improvement still exists.

### SUMMARY OF THE INVENTION

It is therefore an object of the present invention to provide a folder binding device comprising a binding assembly including a rectangular table inclined toward a rear end and being supported by legs, two uprights at both rear corners of the table, a transverse platen moveably provided across the uprights, a rod extended upward from a center of the platen, and two parallel guide posts extended upward from positions proximate both ends of the platen; and a heater releasably mounted at a rear of the binding assembly and supported by the legs, the heater including a front heating member; whereby placing one or more folders on the table with a joint of each folder facing the platen wherein each folder has a plurality of orderly sheets put together by adhesive, lowering the platen by pushing down the rod to press the joint of each folder and cause each joint to be in contact with the heating member, and activating the heating member will melt the adhesive in each folder to bind the sheets thereof after cooling.

In one aspect of the present invention, the heater further comprises a rear handle.

In another aspect of the present invention, the heater further comprises a top control panel for controlling power and temperature of the heating member.

In a further aspect of the present invention, the heater further comprises two front side grooves and each upright has a mounting plate matingly engaged with the groove and secured thereto by snapping.

The above and other objects, features and advantages of the present invention will become apparent from the following detailed description taken with the accompanying drawings.

### BRIEF DESCRIPTION OF THE DRAWINGS

FIG. 1 is a perspective view of a conventional folder in its extended state;

FIG. 2 is side view of the folded folder of FIG. 1 with sheets of file(s) orderly placed therein;

FIG. 3 is a side view schematically depicting the folder in FIG. 2 being placed in on a heating pad of a binder prior to heating for binding;

FIG. 4 is a view similar to FIG. 3 illustrating a folder having a few sheets to be bound;

FIGS. 5 and 6 are perspective views of a preferred embodiment of folder binding device according to the invention taken from front and rear respectively;

FIG. 7 is a side view of FIG. 5 where a single folder is to be bound by the folder binding device;

FIG. 8 is a view similar to FIG. 5 where three folders are to be bound by the folder binding device;

FIG. 9 is a view similar to FIG. 7 where six folders are to be bound by the folder binding device; and

FIG. 10 is an exploded view of the heater shown in FIG. 5.

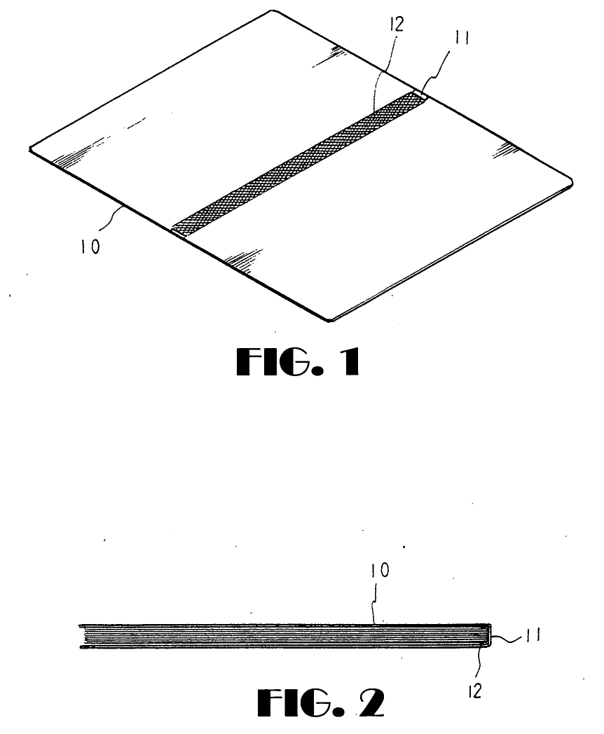

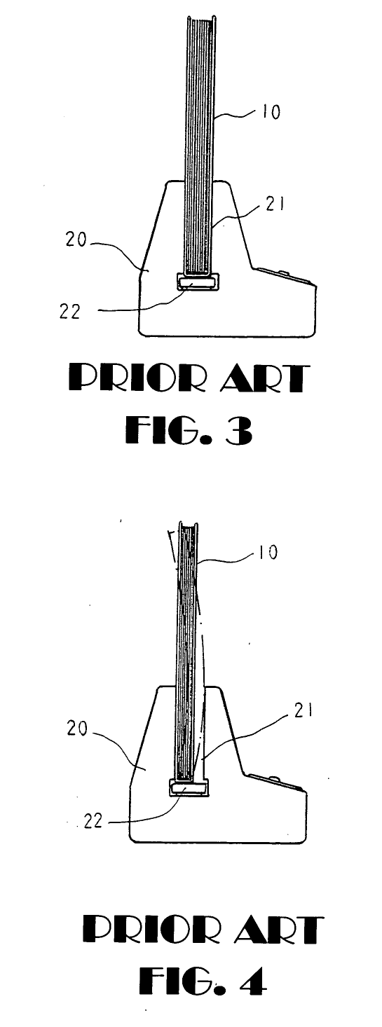

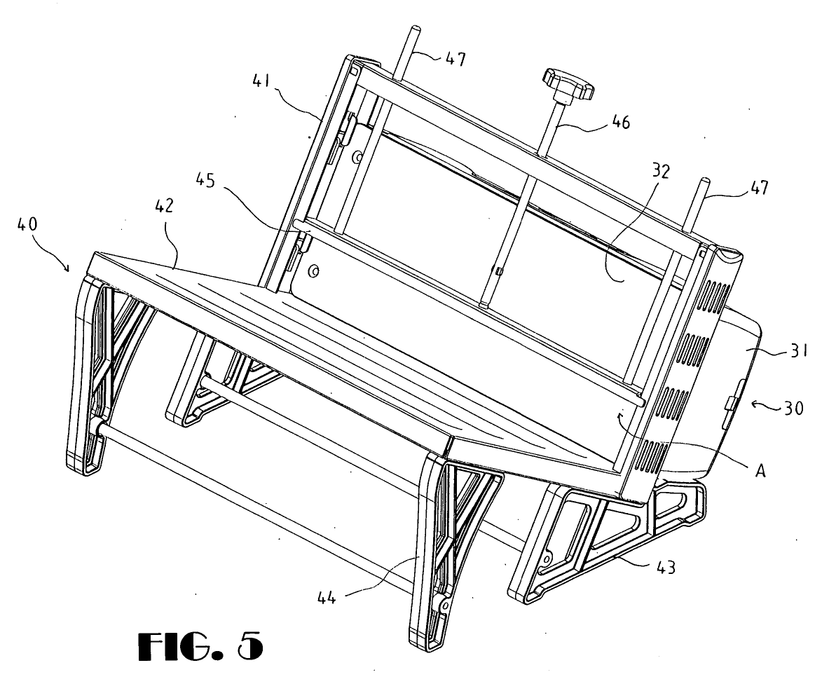

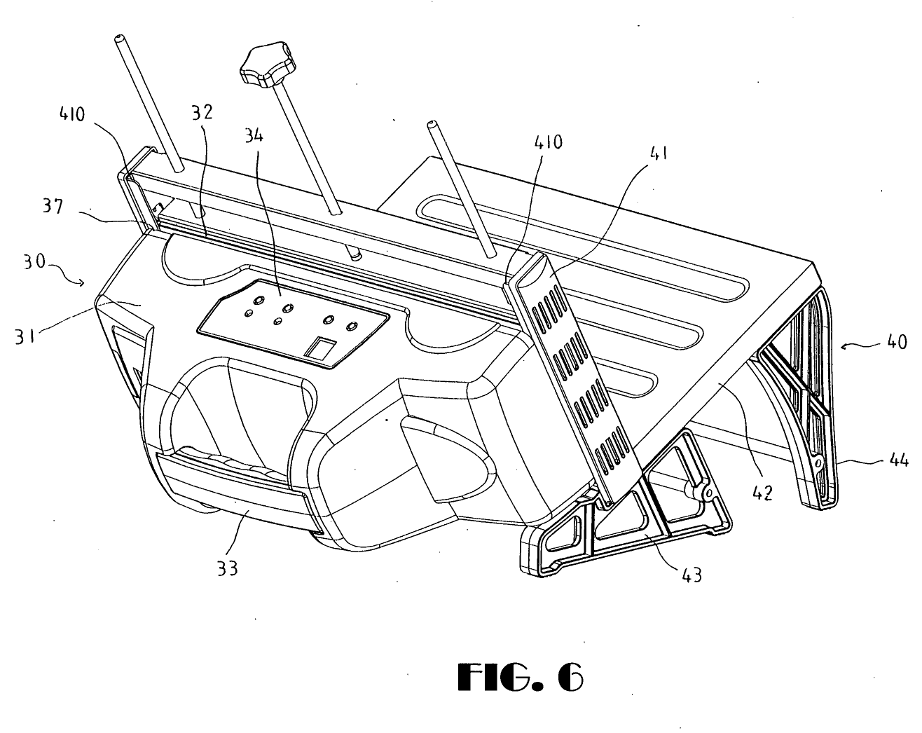

### DETAILED DESCRIPTION OF THE INVENTION

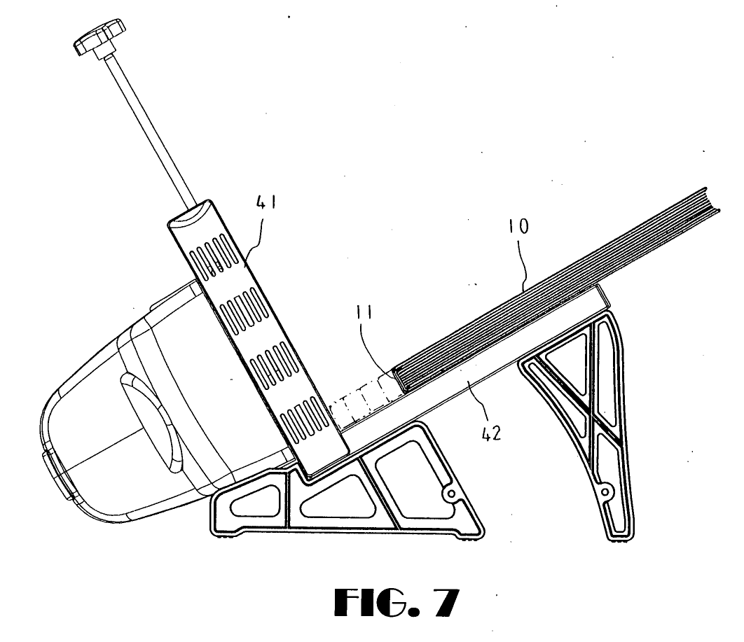

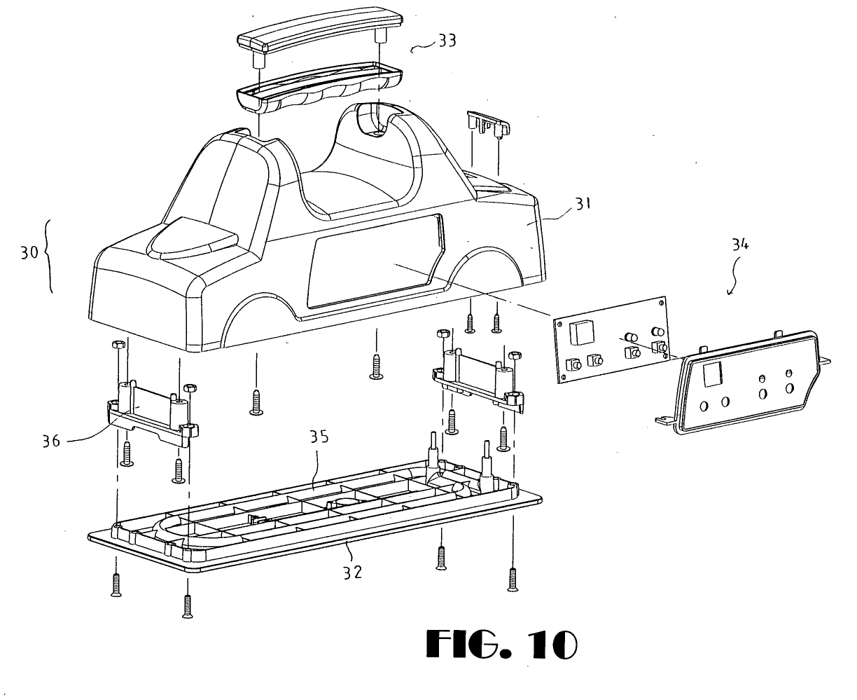

Referring to FIGS. 5 to 10, a folder binding device in accordance with a preferred embodiment of the invention comprises a rear heater 30 and a front binding assembly 40. Each component is discussed in detailed below.

The binding assembly 40 comprises two front legs 44, two rear legs 43 lower than the front legs 44, an inclined, rectangular table 42 fixedly mounted on the legs 43 and 44 (i.e., the front end of the table 42 is higher than the rear end thereof), two uprights 41 at both rear corners of the table 42, each upright 41 having a mounting plate 410, a transverse platen 45 moveably provided across the uprights 41, a rod 46 extended upward from a center of the platen 45, and two side guide posts 47 proximate both ends of the platen 45 and being disposed in parallel relationship with the rod 46. Lower ends of the rod 46 and the guide posts 47 are fixedly formed on the platen 45.

The heater 30 comprises a housing 31, a heating member 32 on a top of the housing 31, a handle 33 across a U-shaped rear end of the housing 31 such that a detached heater 30 can be easily carried by holding the handle 33 (i.e., the heater 30 is detachable and portable), a front heating element 35 in direct heat communication with the heating member 32, a control panel 34 on a top surface of the housing 31 adjacent the heating pad 32 for controlling power (i.e., on/off) and temperature of the heating element 35, two mounting members 36 for fixing the heating element 35 at the housing 31 by fasteners (e.g., screws and bolt and nut combinations), and two side grooves 37 matingly engaged with the mounting plates 410 and secured thereto by snapping (i.e., the heater 30 is secured to the binding assembly 40 and is rested upon the rear legs 43).

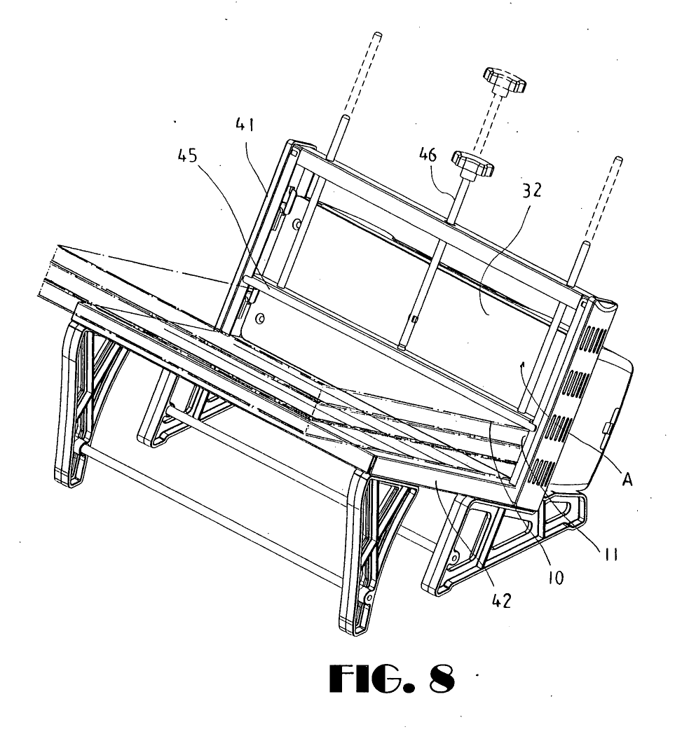

A folder binding operation of the invention will be described in detailed below. As shown in FIG. 7, a single folder 10 having a plurality of orderly sheets are placed on the table 42 with the spine 11 facing a joining portion of the table 42 and the uprights 41. It is clear that the inclined table 42 can facilitate a pushing of the folder 20 toward the joining portion for positioning the spine 11. Next, lower the platen 45 by pushing down the rod 46 to tightly press joints (i.e., heating surface A) of the folder 10. Next, activate the heating element 35 to heat the heating member 32 and thus the folder 10. The adhesive in the folder 10 is melted to completely bind the sheets of the folder 10. As a result, the purpose of binding a single folder is achieved after cooling.

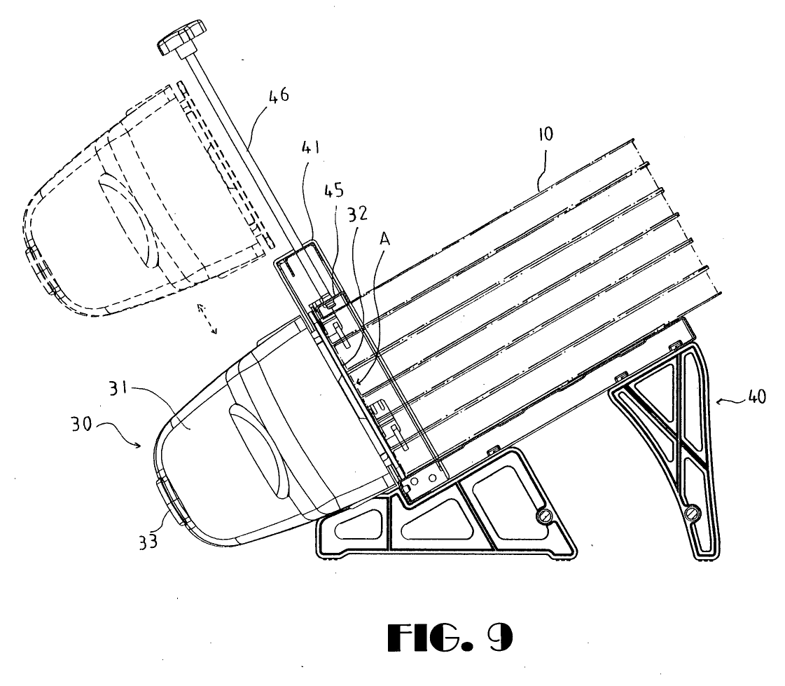

Alternatively, as shown in FIG. 8, three folders 10 each having a plurality of orderly sheets are placed on the table 42 with the spines 11 facing the joining portion. Next, lower the platen 45 to tightly press joints of the folders 10. Next, activate the heating element 35 to heat the heating member 32 and thus the folders 10. The adhesives in the folders 10 are melted to completely bind the sheets of the folders 10. As a result, the purpose of binding a plurality of folders in one operation is achieved after cooling. The configuration shown in FIG. 9 is similar to that shown in FIG. 8. Accordingly, further description is omitted for the sake of brevity.

While the invention herein disclosed has been described by means of specific embodiments, numerous modifications and variations could be made thereto by those skilled in the art without departing from the scope and spirit of the invention set forth in the claims.

What is claimed is:

1. A folder binding device comprising:
a binding assembly including a rectangular table inclined toward a rear end and being supported by legs, two uprights at both rear corners of the table, a transverse platen moveably provided across the uprights, a rod extended upward from a center of the platen, and two parallel guide posts extended upward from positions proximate both ends of the platen; and
a heater releasably mounted at a rear of the binding assembly and supported by the legs, the heater including a front heating member;
whereby placing one or more folders on the table with a joint of each folder facing the platen wherein each folder has a plurality of orderly sheets put together by adhesive, lowering the platen by pushing down the rod to press the joint of each folder and cause each joint to be in contact with the heating member, and activating the heating member will melt the adhesive in each folder to bind the sheets thereof after cooling.

2. The folder binding device of claim 1, wherein the heater further comprises a rear handle.

3. The folder binding device of claim 1, wherein the heater further comprises a top control panel for controlling power and temperature of the heating member.

4. The folder binding device of claim 1, wherein the heater further comprises two front side grooves and each upright has a mounting plate matingly engaged with the groove and secured thereto by snapping.
